(19) United States
(12) Patent Application Publication
(10) Pub. No.: US 2008/0125649 A1
(43) Pub. Date: May 29, 2008

(54) Automatic object tracking in a region of interest

(76) Inventors: Andreas Meyer, Mohrendorf (DE); Winfried Lurz, Furth (DE); Anton Nekovar, Neunkirchen a. Brand (DE)

Correspondence Address: BRINKS HOFER GILSON & LIONE, P.O. BOX 10395, CHICAGO, IL, 60610, US

(21) Appl. No.: 11/522,594

(22) Filed: Sep. 18, 2006

(51) Int. Cl. H05G 1/02

(52) U.S. Cl. 600/426

(57) ABSTRACT

A medical treatment system is described having an imaging device and a patient examination table. At least one of the imaging device or the patient table has a motorized or hydraulic mechanism for moving the imaging device and the patient examination table relative to each other. A processor tracks the position of a catheter or a bolus of contrast enhancing material so that the catheter or bolus is maintained within the field of view of the imaging system, or within the displayed image where the images have been previously obtained. The position of the catheter may be determined by image analysis or magnetic or acoustic means, and the position of the bolus may be obtained by image analysis.

### TECHNICAL FIELD

The present application relates to the use of a medical imaging device in the management of treatment of a patient which may include catheterization or administration of a contrast agent.

### BACKGROUND

In the field of interventional medical procedures, X-ray systems are used both in angiography and in cardiology. These X-ray systems normally include a patient supporting device, such as an examination table or a stretcher, and a gantry that supports the X-ray system detector and emitter, including the diaphragm (collimator).

During such medical interventions, the examination table must be tracked both longitudinally and transversely, depending on the examination table position, in order to position the examination table in the field of view of the X-ray system. This tracking is done manually by the equipment operator. Often, the operation of the system and guidance of the examination table are done by one person, so that the person has to frequently reach away from the examination table to operate the equipment.

In many interventional techniques, contrast agents are injected in order to visualize the branching vessel pattern, and the equipment operator must follow the contrast agent bolus by moving the examination table relative to the X-ray or imaging or sensor system.

### SUMMARY

A medical imaging system is described, including an imaging system, an examination table, and a processor configured to maintain a position of an object or area in a patient positioned on the examination table within the field of view of the imaging system or the displayed image.

At least one of the examination table or the imaging system is movable operable to maintain the position of an object or area within a field of view of the imaging system or a displayed image. The position of the object, which may be a catheter, may be determined from image analysis, location of a magnetic sensor associated with the catheter, stent or other object of interest, or by acoustic means. Where the area is a bolus of contrast enhancing material, image analysis may be used. The images may be real-time, contemporaneous, or previously obtained.

At least one of the examination table or the imaging device is movable with respect to the other of the examination table or the imaging device by a motor or hydraulic mechanism, and the control signals for the movement are provided directly or indirectly by the processor.

A method of medical imaging is disclosed, the method including placing a patient on an examination table, obtaining an image of the patient with an imaging device, moving at least one of the examination table or the imaging device so that an object or area in the patient body is maintained within a field of view of the imaging device or a displayed image, and the motion of at least one of the examination table or the imaging device is effected by a motor or a hydraulic device.

### BRIEF DESCRIPTION OF THE DRAWINGS

FIG. 1 illustrates the relationship of a patient on an examination table to an imaging device and associated electronic equipment; and

FIG. 2 is a block diagram illustrating an embodiment of the method.

### DETAILED DESCRIPTION

Exemplary embodiments may be better understood with reference to the drawings. Like numbered elements in the same or different drawings perform equivalent functions. In the interest of clarity, not all the routine features of the implementations described herein are described.

A system and method for automatically varying the position of a patient examination table with respect to a treatment apparatus is described. In an aspect, the system includes a motor-driven adjustment apparatus to adjust the position of at least one of the patient examination table or imaging apparatus. The direction of motion of at least one of the patient examination table or the imaging apparatus is in at least one of a longitudinal or a transverse direction.

The position of a treatment device (such as a guide wire, catheter, or the like) within a region of interest (ROI) may be determined by, for example, an acoustic or a magnetic locating system, such as MediaGuide (available from MediGuide, Inc., Haifa, Israel), by using image-based object recognition for the device or a contrast agent bolus, or manually designating the position thereof.

Magnetic tracking is a technology based on using a transmitter associated to create a magnetic field, and on measuring the effect of the field on a tiny sensor in real time and computing its spatial position and orientation with respect to a reference coordinate system. The sensor may be associated with a known position on a treatment device. Magnetic tracking devices can operate without a line-of-sight optical path between the transmitter and the sensor, and without emission of X-rays.

For magnetic tracking systems, sensors may measure the magnetic field of a transmitter associated with a tip of a catheter or other device, and locate the catheter, stent or other device in a coordinate system related to the patient or treatment device. The coordinates may be transferred in real time to previously or contemporaneously generated X-ray or other images and displayed in radiography images or 3D reconstructions. In such circumstances, the images of the patient and a representation of the treatment device may be merged into a composite image for visualization.

An automatic tracking function may be initiated after the initial object recognition, but may also be capable of being deselected at a later time. The current positions of the treatment device or of the contrast agent bolus may be transmitted to the examination table controller, imaging system controller, or treatment device controller.

Herein, the term “bolus” represents an image of a mass of material that is the result of one or more administrations of a contrast agent into the vascular system or perfused into tissue or organs so as to aid in visualizing the body parts using the imaging apparatus. Contrast agents may be administered in different ways: some are given as a drink, others are injected or delivered through an intravenous line or an enema. For example, contrast agents containing iodine are used to image the gallbladder, urinary tract, blood vessels, spleen, liver and bile duct. Iodine contrast agents are clear liquids and usually are injected.

Prior to the administration of a contrast agent, an X-ray image without contrast agent, which may be termed a mask image, may be obtained in one or more positions of the imaging system and stored in an image memory. In such a procedure, the imaging device or the examination table may be moved so that a larger area of the body may be viewed in a composite image. The images made using the contrast agent may be called filling images, and may be made with the same imaging device positions as the mask images. The corresponding mask and filling images may be subtracted from each other so that only the vessels with the contrast agent are now apparent. The position of a treatment device, where position is located by magnetic or acoustical devices, may be shown with respect to a representation of, for example, the vessels, without the distraction of images of the bones or soft tissue.

The synchronization of the images with small body motions of the patient by the use of EKG (electrocardiogram) or breathing sensors may improve the quality of the display.

In an embodiment, the position of the portion of the examination table supporting the patient is altered by the motors. Under the control of the controller, the controlled device (e.g., the examination table or the imaging device) is translated such that the treatment device or the contrast agent bolus remains within the field of view of the imaging system or a displayed image.

The imaging system may be, for example, a C-arm X-ray system, and various image processing and recognition algorithms, as will be known to persons skilled in the art, may be employed to facilitate the detection, recognition and control processes.

Controlling the relative position of the examination table and the imaging device position may include hysteresis so that the relative position of the patient and the treatment or image apparatus does not move when small changes in the position of the object to be tracked occur. The hysteresis may be adjustable to adapt to different medical procedures.

Either the gantry supporting the imaging device or the examination table may be selectively moved. If the gantry has the applicable axes of motion in coordinate space available, a robotic control may permit suitable motions of the gantry so as to orient the imaging device with respect to the patient on the examination table or to the treatment device. When gantry motion is used for adjusting the relative positions of the patient and the imaging device, or the imaging device with respect to the treatment device, the patient may remain stationary with respect to the treatment room, and to other ancillary equipment.

The sensor portion of the imaging apparatus, the examination table, treatment devices and any tracking device may be located in a therapy room, and some or all of the signal and data processing and data display may also be located in the therapy room, but all of the equipment and functionality not directly associated with the sensing of the patient and the position of the treatment device, may be remotely located. Such remote location of portions of the system may be facilitated by high-speed data communications on local area networks, wide area networks, or the Internet. The signals representing the data and images may be transmitted by modulation of representations of the data on electromagnetic signals such as light waves, radio waves, or signals propagating on wired connections.

The combination of hardware and software to accomplish the tasks described herein may be termed a platform”. The instructions for implementing processes of the platform, may be provided on computer-readable storage media or memories, such as a cache, buffer, RAM, removable media, hard drive or other computer readable storage media.

Computer readable storage media include various types of volatile and nonvolatile storage media. The functions, acts or tasks illustrated in the figures or described herein may be executed in response to one or more sets of instructions stored in or on computer readable storage media. The functions, acts or tasks may be independent of the particular type of instruction set, storage media, processor or processing strategy and may be performed by software, hardware, integrated circuits, firmware, micro code and the like, operating alone or in combination. Some aspects of the functions, acts, or tasks may be performed by dedicated hardware, or manually by an operator.

Communications between the devices, systems and applications of the platform may be by the use of either wired or wireless connections. Wireless communication means may include, audio, radio, lightwave or other techniques not requiring a physical connection between a transmitting device and a corresponding receiving device. While the communication is described as being from a transmitter to a receiver, this does not exclude the reverse path, and a wireless communications device may include both transmitting and receiving functions.

In an embodiment, the examination table is automatically moved so that a bolus or a treatment device is maintained within the field of view of the imaging device.

In another embodiment, the imaging device is moved with respect to one of the treatment device or the examination table such that the treatment device is maintained within the field of view of the imaging device or the displayed image.

In yet another embodiment, both the examination table and the imaging devices are moved such that the bolus or the treatment device is maintained within the field of view of the imaging device. Each of the embodiments may introduce hysteresis in the movement commands so that relative movements of any one of the examination table, imaging device or treatment device that are less than some threshold distance amount do not result in movement of either of the imaging device or the examination table.

Treatment devices may, for example, include balloon catheters, stents, guidewires, microcatheters, and electrophysiology (EP) mapping and ablation catheters.

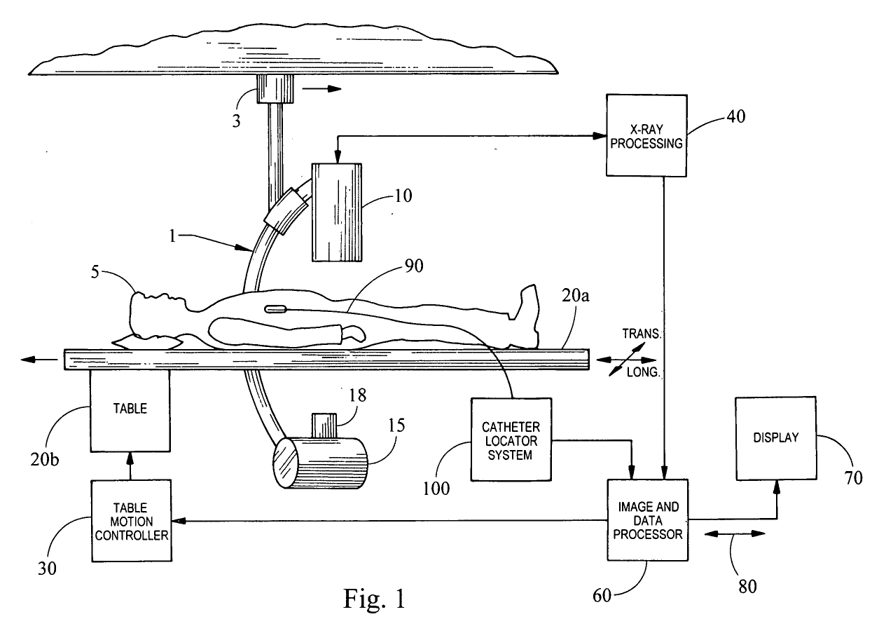

As shown in FIG. 1, a patient 5 is positioned on an examination table 20, such that an imaging system 1, which may be an X-ray imaging device such as a C-arm X-ray system may obtain radiographic images. The imaging system 1 may include an X-ray detector 10, which may a device for obtaining real-time X-ray images, as is known in the art, or a later developed means, a source of X-radiation 15, positioned on an opposite side of the patient 5, and, optionally, a diaphragm or collimator 18 to limit the angular extent of the radiation. The imaging system 1 may be mounted to a ceiling by an adapter 3, or have a floor or wall mounting arrangement. The controls, high-voltage power and processing 40 for the X-ray device are known in the art and need not be described in detail.

The base 20b of the table is positioned on the floor of the treatment room (not shown), and the portion 20a of the table where the patient 5 is placed is movable with respect to a base 20b of the table that is in contact with the floor. Motion of the table is controlled by a controller 30 which controls motors capable of translating the table 20a in at least a longitudinal direction (as shown in the drawing by the arrow), and may also be capable of translating the table in a transverse and/or a vertical direction in response to either manual operator input or in response to control signals received from another unit such as a processor. Alternatively, the imaging system 1 may be similarly translated in a longitudinal (shown by the arrow near the ceiling mount) a transverse, or a rotational direction.

An image and data processor 60 is provided to record and process the image data obtained by the imaging system 1. The data may be recorded as a preliminary act, or real-time images obtained, or a combination of the two acts. Mask (no contrast enhancement) and filling (with contrast enhancement material) images may be obtained and subtracted to provide an enhanced image of the vascular or other body system.

A catheter 90 may be inserted into the patient 5 and, for example, threaded through the vascular system. The coordinate position of the catheter 90 may be determined by use of the imaging system 1, which may be a C-arm X-ray system used in a fluoroscopic mode, or by a magnetic or acoustical position location system 100. The position data is communicated to the image and data processor 60 where such coordinate position may be used to locate the treatment device, such as the catheter 90, with respect to the images of the patient body. A composite image or other desired image type or data may be displayed on a display 70.

The data, images and other information may be transmitted to another location, which may be outside the treatment room for further analysis, archival storage, administrative purposes, or the like. Such transmission may be through a data interface 80, which may be an Ethernet interface, or other interface to a local area network or a wide area network such as the Internet. The data may be transmitted by modulation of the data signal on a carrier wave.

In an aspect, the data and image processor 60 may recognize the image of the catheter 90, or the bolus, or be provided with a coordinate location of the sensor associated with the catheter 90 by the location system 100. The image and data processor 60 may send control signals to the table controller 30 such that the location, for example, of the catheter tip or other catheter portion, or the centroid of the bolus or other bolus portion is maintained within the field of view of the X-ray system. Alternatively, the table may be maintained in a fixed position, and the imaging system 1, which may, for example, be a C-arm X-ray system, may have a robotic positioning capability such that, for example, the catheter tip or the centroid of the bolus may be maintained within the field of view of the X-ray system.

In another aspect, where a difference image of the mask and filled images may been obtained, and the images cover an area (the data image field of view) that is wider than the instantaneous field of view of the imaging system 1, the image and data processor 60 may produce a synthetic image of the catheter 90 on such a difference image for display on the display 70, without further X-radiation.

A method of automatically tracking an object in a region of interest is disclosed. The patient is placed on an examination table in a treatment room. The examination table coordinate system may be located with respect to an imaging device such a C-arm X-ray imaging system. A treatment device such as a catheter may be introduced into the patient body or a contrast agent administered to assist in image visualization may. A region of the body corresponding to a selected portion of the treatment device or the bolus associated with the contrast agent may be identified. At least one of the patient examination table, the treatment device or the imaging device may be moved relative to each other such that a selected portion of the treatment device or the bolus is maintained within the field of view of the imaging device or the displayed image.

In an aspect, the spatial coordinates of the treatment device are determined, for example, by a magnetic sensor attached near a tip thereof. The spatial coordinates may be termed the device location. Initially, at least one of the treatment table or the imaging device is positioned such that the device location is observed at approximately the center of the image produced by the imaging device. A synthetic box or circle enclosing an area may be displayed with the image to aid in centering the device location. One of several methods of maintaining the device location within the field of view of the imaging device may be used.

For example, a further circle may be defined as the limit to which the device may be permitted to depart from the initial central region. Motions within the circle may not result in any motion of the examination table or the imaging device. When the device location places the device outside of the circle, at least one of the examination table or the imaging device is translated so as to move the device so that the device location is placed within the circle. The speed of motion and the increments of motion will depend on the type of procedure being performed.

Alternatively, the initial central position is recorded, and the relative position of the device with respect to the initial central position is determined. If the device location has moved such that the image of the device has deviated from the initial central position by greater than a specified linear distance (a hysteresis distance), at least one of the imaging device or the treatment table is actuated to translate the relative position of the device such that the device is returned to approximately the central position. As such, since the device has moved physically, the image displayed about the central position will change correspondingly, but the device will remain approximately centered.

In another alternative, a difference image of the mask and filled images may been obtained, and the images cover an area (the data image field of view) that is wider than the instantaneous field of view of the X-ray device. Further, the relationship of the image data to the spatial orientation of the examination table is known. When a treatment device is moved with respect to the patient, a synthetic image of the treatment device may be initially centered in the displayed image, and the displayed image translated with respect to the treatment device to maintain the device position in the center of the display.

Motion of the treatment table or the imaging device may be inhibited during certain portions of the treatment of the patient. During such periods, the device position may move from the central area by more than a hysteresis distance without resulting in a motion of either the imaging device or the treatment table.

The position of the treatment table or the imaging device may also be controlled manually.

In an aspect, at least one of the examination table or the imaging device is controllable so that a position of the examination table and the imaging device may be altered relative to each other. The means of controlling the position may be by, for example, a motor or a hydraulic system receiving control signals. The means of providing control signals may be, for example, a processor configured to identify the position of the catheter or the bolus with respect to the field of view or display of the imaging system. The means for identifying the position may include, a magnetic sensing system where the position of a magnetic sensor associated with the catheter is determined, an acoustic sensor, or an X-ray imaging device producing at least one of mask or filled images, or subtraction images, and using such images or position information to identify and track the desired object or area.

The method may also include the acts of displaying images of the tracked area within the field of view of the imaging device, and transmitting some or all of the data obtained by the sensors to another location which may be remote from the remainder of the treatment suite for recording, further analysis, or control. The location of equipment for performing this method is not limited to the treatment room.

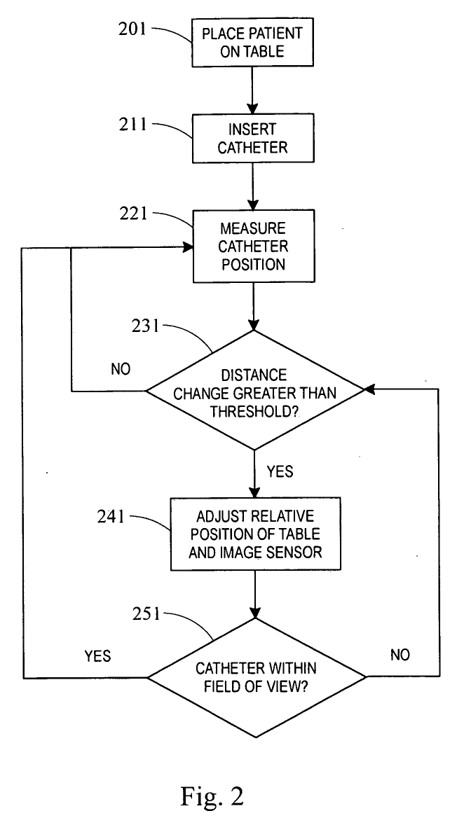

In an embodiment 200 of the method as shown in FIG. 2, at step 201 the patient is placed on the examination table; at step 211 a catheter or other treatment device is inserted in the patient vascular system and guided to a starting position; at step 221, the coordinate position of the catheter is determined, and the coordinate position analyzed in step 231 to determine if the catheter position has change by more than a predetermined distance from the last time the relative positions of the examination table and the image sensor has been adjusted. If the threshold distance is not exceeded, the process returns to measuring the position of the catheter, repeating step 221. If the threshold distance is exceeded, then the relative position of the treatment table and the image sensor is adjusted at step 241. After making the adjustment or relative position, the position of the catheter is compared with the field of view of the image sensor at step 251 to determine whether the catheter is within the field of view. If the catheter is within the field of view, then the process returns to the measurement of catheter position at step 221; however if the catheter is outside of the field of view of the image sensor, step 241 is repeated in order to bring the catheter into the field of view. The test in step 231 may be called hysteresis, as no change in the relative position of the examination table or image sensor is made unless the distance moved by the catheter is greater than a threshold.

While the methods disclosed herein have been described and shown with reference to particular acts performed in a particular order, it will be understood that these acts may be combined, sub-divided, or reordered to from an equivalent method without departing from the teachings of the present invention. Not all of the acts of the method are performed in every embodiment thereof. Accordingly, the order and grouping of acts is not a limitation of the present invention.

Although only a few exemplary embodiments of this invention have been described in detail above, those skilled in the art will readily appreciate that many modifications are possible in the exemplary embodiments without materially departing from the novel teachings and advantages of the invention. Accordingly, all such modifications are intended to be included within the scope of this invention as defined in the following claims.

What is claimed is:

1. A medical treatment apparatus, comprising:
an imaging system;
an examination table;
a processor configured to identify a position of an object or area in a patient positioned on the examination table,
wherein at least one of the examination table or the imaging system is operable to maintain the position of the object or area within a field of view of the imaging system or a displayed image.

2. The apparatus of claim 1, wherein the imaging system is an X-ray apparatus.

3. The apparatus of claim 1, wherein a position of at least one of the imaging system or the examination table is changed by a motor or a hydraulic device.

4. The apparatus of claim 1, further comprising:
a magnetic sensor associated with a catheter;
a magnetic field source located with respect to one of the imaging system or the examination table;
wherein the position of the magnetic sensor representing the object is determined with respect to at least one of the examination table or the imaging device.

5. The apparatus of claim 1, wherein positions of the examination table and the imaging system are stationary when the total distance movement of the tracked area or the object is less than a predetermined distance value.

6. The apparatus of claim 5, where the predetermined value is set by one of a manual operator input or a value associated with a procedure being performed.

7. The apparatus of claim 1, wherein the field of view of the imaging device includes images obtained prior to identifying the object or area and where the images are stored in a memory.

8. A medical treatment apparatus, comprising:
an imaging system;
an examination table;
a data memory;
wherein at least one of the examination table or the imaging system is operable move the patient or the imaging device with respect to each other such that an image of the patient is obtained and stored in memory, and
a processor configured to identify a position of an object or area in a patient positioned on the examination table and to display a previously obtained image such that the object or area whose position is determined are within the displayed field of view of the image.

9. The apparatus of claim 8, wherein the image is obtained by an X-ray device.

10. The apparatus of claim 9, wherein images are obtained with and without a contrast agent.

11. The apparatus of claim 10, wherein the processor is configured to produce a differential image between the image obtained with and without the contrast agent.

12. The apparatus of claim 8, wherein the position of the object is combined with the image to form a composite image.

13. A medical treatment apparatus, comprising:
means for supporting a patient;
means for imaging the patient;
means for determining a position of a object or an area in the patient; and
means for maintaining the position of the object or area within the field of view of the means for imaging or within a displayed image.

14. A method of medical treatment, the method comprising:
placing a patient on an examination table;
obtaining an image of the patient with an imaging device; and
controlling the movement at least one of the examination table or the imaging device with a processor configured so that an object or area in the patient body is maintained within a field of view of a displayed image,
wherein the motion of at least one of the examination table or the imaging device is effected by a motor or a hydraulic device.

15. The method of claim 14, wherein the object is a catheter or bolus of contrast enhancing material.

16. The method of claim 14, wherein a magnetic sensor is used to determine a coordinate position of the object.
